(19) United States
(12) Patent Application Publication
(10) Pub. No.: US 2014/0019294 A1
(43) Pub. Date: Jan. 16, 2014

(54) RETAIL LOCATION CONCIERGE STATION

(71) Applicant: Rosemary Hill, Jacksonville, FL (US)

(72) Inventor: Rosemary Hill, Jacksonville, FL (US)

(73) Assignee: Bank of America Corporation, Charlotte, NC (US)

(21) Appl. No.: 13/546,520

(22) Filed: Jul. 11, 2012

(51) Int. Cl. G06Q 30/00

(52) U.S. Cl. 705/26.7

(57) ABSTRACT

Apparatus and methods for a retail location concierge station are provided. Apparatus and methods in accordance with principles described herein may be initiated by a customer logging into an online portal prior to visiting a retail location. Apparatus and methods may be initiated by the customer entering a retail location and providing identification information at the station. The station may present products offered by the entity that the customer may wish to add to their existing relationship with the entity. These products may be pre-selected based on information known to the entity about customer. The station may transmit products selected by the customer to an employee of the entity. The employee may review the products selected by the customer prior to servicing the customer. The station may present additional products that may accomplish an express or implied objective of the customer.

### FIELD OF TECHNOLOGY

Aspects of the present disclosure relate to providing enhanced customer service at a retail location.

### BACKGROUND

A customer of an entity may consume goods and/or services (hereinafter, “products”) offered by the entity. The customer may access the products using a variety of distribution channels.

For example, a customer of a financial entity may access products via an online portal of the financial entity. The online portal may provide access to financial products offered by the entity. The online portal may be accessed at any time and at a location convenient for the customer.

The online portal may not provide access to all products offered by the entity. For example, a customer may only be able deposit a valuable item in a safe deposit box by traveling to a “brick and mortar” location of the financial entity.

The online portal may be unable to adequately address a concern or question of the customer regarding a specific product. The question may involve financial particulars too complex to be addressed by an automated system. The customer may wish to pose a question in person to an employee of the financial entity. The customer may wish to discuss a personal objective with the employee.

The objective may include a financial objective. For example, the customer may wish to link various accounts held at a financial institution. The customer may wish to link a purchasing instrument to an investment account. The objective may include any suitable objective.

The retail location may be staffed by employees of the entity. The employees may be knowledgeable regarding a range of products offered by the entity. The employees may be knowledgeable about how one or more financial products may operate. A knowledgeable employee may need some time to obtain background information about the customer. The knowledgeable employee may need some time to obtain more detailed information about the specific product requested by the customer. After obtaining the background and detailed information, the employee may better advise the customer.

To advise the customer, the employee may spend time researching alternative options that may accomplish an objective of the customer. The customer may be aware in a general sense of an objective, but may not be aware of a range of product offerings that may implement the objective. The customer may not be aware of an interaction among financial products that may provide an outcome desired by the customer. The employee of the entity may take time to research available options before advising the customer.

As a result of an amount of time spent servicing each customer, employees of the entity may be limited in the number of customers that may be served. As a result of the amount of time spent servicing each customer, a customer arriving at a retail location may need to wait for an employee to finish serving a prior customer.

It would be desirable to reduce time that a customer spends waiting to be served at a retail location of an entity. It would be desirable to increase employee efficiency by providing the employee information regarding a customer and an objective of the customer before the customer arrives at the retail location. It would be desirable to increase customer satisfaction with services provided at a retail location. It would be desirable, therefore, to provide apparatus and methods for a retail location concierge station.

### SUMMARY

Apparatus and methods for a retail location concierge station are provided. The station may include a kiosk for servicing a customer at a financial institution retail location. The kiosk may include a receiver device.

The receiver may be configured to receive a first input. The first input may include information encoded on a purchasing instrument of the customer. The receiver may receive a second input. The second input may include information transmitted from a mobile device of the customer. The receiver may receive a third input. The third input may include a biometric characteristic of the customer. The first, second and third inputs may authenticate and identify the customer at the kiosk.

The kiosk may include a processor device configured to determine the pre-selected financial products. The pre-selected financial products may be determined based on financial information associated with the customer.

The kiosk may include a first display configured to communicate the pre-selected financial products to the customer. The pre-selected financial products may be determined based on one or more of the first input, the second input and the third input.

The kiosk may include an input device configured to receive a selection of the customer, the selection including at least one of the pre-selected financial products.

The processor device may be configured to generate a product-offering matrix. The matrix may be based on the financial information and the selection of the customer.

The kiosk may include a second display configured to communicate, to an employee of the financial institution an image of the customer, a name of the customer, the selection of the customer, the product-offering matrix, and a greeting.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a schematic diagram of a general purpose digital computing environment in which one or more aspects of the present invention may be implemented;

FIG. 2 shows illustrative apparatus that may be used in accordance with principles of the invention;

FIG. 3 shows illustrative information that may be used in accordance with principles of the invention;

FIG. 4 shows an illustrative process that may be used in accordance with principles of the invention; and

FIG. 5 shows an illustrative process that may be used in accordance with principles of the invention.

### DETAILED DESCRIPTION OF THE DISCLOSURE

Apparatus and methods for a concierge station are provided. The concierge station may be located at a retail location. The retail location may be a “brick and mortar” location. The retail location may be any suitable location for servicing customers.

Apparatus and methods in accordance with principles described herein may reduce time a customer spends waiting to be serviced at a retail location. Apparatus and methods in accordance with principles described herein may increase customer satisfaction with service provided at a retail location. Apparatus and methods in accordance with principles described herein may provide infrastructure and tools for an employee of an entity to efficiently serve a customer.

The retail location may be any suitable location that provides access to products offered by an entity. The entity may be a financial institution, a technology provider or any suitable provider of goods or services. The products may include financial products and financial instruments. Embodiments may include apparatus and methods for a concierge station at any suitable location that provides products offered by an entity. The retail location may be a “brick and mortar” retail location.

Apparatus may include a customer-facing concierge kiosk. The kiosk may provide a customer interface at a retail location. When a customer enters the retail location, the customer may interact with the kiosk before interacting with an entity employee.

The kiosk may include a receiver device configured to receive a first input from the customer. The first input may include information encoded on a purchasing instrument of the customer.

For example, the customer may enter the retail location and swipe a purchasing instrument at a card reader of the kiosk. The purchasing instrument may include identifying information that authenticates the customer. The purchasing instrument may be a credit card, a debit card, a check and bank card, a stored-value card, a bar-coded article, an instrument or device that includes a contactless chip, such as an ISO14443-compliant contactless chip. The purchasing instrument may be any suitable electronic, encoded or information-bearing purchasing device that may convey identification information to a receiver.

The receiver may be configured to receive a second input. The second input may include information transmitted from a mobile device of the customer. The mobile device may transmit identification information to authenticate the customer.

For example, the customer may use a mobile device to initiate a log on to an online portal of the entity. The customer's authenticated user name and password may identify the customer. The receiver may receive the customer's user name and password.

The kiosk may detect a presence of the mobile device in a vicinity of the kiosk. The kiosk may transmit a signal that prompts the customer to enter a password on the mobile device. The mobile device may transmit the password to the kiosk. The receiving device may receive the password.

The second input may be transmitted from a remote location. The remote location may be centimeters, meters or kilometers distant from the kiosk.

For example, a customer may log on to an online portal of the entity and indicate that he is en-route to the retail location. The customer may enable GPS location services of the mobile device. The kiosk may be configured to track progress of the customer towards the retail location. The kiosk may inform an employee of the entity of progress of the customer. The kiosk may inform the entity employee of an estimated arrival time of the customer. The kiosk may inform the entity employee that the customer has arrived at the retail location.

The receiver may be configured to receive a third input. The third input may include a biometric characteristic of the customer.

For example, the kiosk may include a biometric scanner. The scanner may be configured to read a biometric characteristic of the customer. The customer, upon entering the retail location may input a biometric characteristic using the biometric scanner. The biometric characteristic may identify the customer. Exemplary biometric characteristic may include iris recognition, fingerprints, voice pattern or any suitable biometric characteristic that uniquely identifies the customer.

The kiosk may include a first display. The first display may be configured to communicate pre-selected products to the customer. The pre-selected products may be financial products.

The financial product may be any suitable financial product. Exemplary financial products may include interest-bearing checking, savings, certificate of deposit (“CD”), individual retirement account (“IRA”) or any suitable financial product. Financial product may include a pricing scheme. The pricing scheme may include a rate of interest, a fee schedule, a fee for providing a financial service, a promotional financial arrangement or any suitable pricing scheme. Financial product may include any suitable pricing scheme that influences performance of a financial product. Financial products may include any suitable product offered by a financial institution.

The kiosk may include a processor device. The processor device may be configured to determine the pre-selected financial products. The pre-selected financial products may be determined by choosing from among financial products offered by an entity.

The pre-selected financial products may be determined based on the identity of the customer. The customer may be identified based on one or more of the first, second and third inputs. The pre-selected financial products may be determined based on one or more of the first input, the second input and the third input.

For example, the customer may enter a retail location and swipe a purchasing instrument at a card reader of the kiosk. The first display may prompt the customer to enter a pin associated with the purchasing instrument to confirm an identity of the customer. Upon authenticating the identity of the customer, the processor may determine pre-selected financial products that the customer may utilize. The pre-selected financial products may include new financial products or options to alter an existing customer-entity relationship. The first display may communicate the pre-selected products to the customer.

The processor may determine the pre-selected financial based on financial information associated with the customer. The financial information may be associated with the customer based on identification of the customer.

For example, the processor may be configured to determine the pre-selected products based on a class of checking account held by the customer, balances in the checking account, a principle amount of an auto loan or any suitable financial information associated with the customer.

The pre-selected financial products may be based on any suitable information known to the entity about the customer. For example, the pre-selected financial products may be determined based on an address of the customer or on recent purchases of the customer using a purchasing instrument. The address or purchase history may be associated with demographic information. The demographic information may be correlated to a category of financial products. The information known to the entity about the customer may indicate that the customer may be interested in a specific financial product.

The kiosk may be configured to derive information from financial information known to the entity about the customer. For example, an entity may have issued an auto loan to the customer. Based on the make and model of the vehicle purchased using the auto loan, the kiosk may be configured to derive financial products that may be of interest to the customer.

As a further example, the entity may detect that an investment instrument held by the customer is nearing maturity. The processor may determine that the customer may be looking for a new investment product in the near future. The pre-selected financial products may include current investment products offered by the entity.

The kiosk may include an input device. The input device may be configured to receive a selection of the customer. The selection may include at least one of the pre-selected financial products. The customer may select more than one product. The selection may indicate that the customer is interested in learning more about the selected product.

The input device may be a touch screen. For example, the input device may be the mobile device of the customer. The customer may select, using a mechanism of the mobile device, a financial product of interest. The mechanism may be a touch screen. The mobile device may transmit the selected financial product to the receiver.

If the pre-selected financial products do not include a financial product of interest to the customer, the customer may instruct the kiosk to search for additional financial products. For example, the customer may wish to obtain information regarding a specific product or promotion seen in an advertisement. The customer may enter a request for the specific product seen in an advertisement. The customer may enter the request using the input device.

The kiosk may be configured for the customer to browse financial products offered by an entity. The customer may browse and select a financial product of interest.

In some embodiments, the customer may be presented an opportunity to enter a custom request. The custom request may describe a product or describe an objective the customer seeks to accomplish. For example, the customer may not be aware of specific products offered by the entity. However, the customer may be able to describe a financial objective. The first display may present categories of financial products offered by the entity. The request may include a category selected by the customer. The category selected by the customer may be directed toward achieving an objective desired by the customer.

The processor device may be configured to determine one or more products that may meet the objective of the customer. The custom request may be transmitted to an employee of the entity for analysis. The employee may determine one or more products that accomplish the objective described by the customer. The request may be the selection of the customer.

In some embodiments the customer may view the pre-selected financial products and input a selection prior to arriving at the retail location. For example, the customer, at home, may log on to an online portal of the entity. The online portal may allow the customer to view the pre-selected financial products. Via the online portal, the customer may select a financial product. The selection may include a financial product of interest to the customer. The selection may include a request to consult with an employee of the entity at a retail location.

The selection and request of the customer may be transmitted to the entity. The entity may review the customer's selection and assign an entity employee to service the customer. The employee assigned to service the customer may be knowledgeable about products selected by the customer. The employee may be provided an opportunity to review the selection before servicing the customer at the retail location.

The processor may be configured to order the pre-selected financial products. The order may be based on the financial information associated with the customer.

For example, a product may be a special promotion only available for a limited period of time. The special promotion may be listed first among pre-selected products. A first listing may be most visible to the customer. As a further example, the first listed pre-selected financial product may be a product that the processor selected as the best match to an objective of the customer.

The processor may be configured to generate a product-offering matrix. The matrix may be based on the financial information associated with the customer and the selection of the customer. The matrix may include options and potential offers for the customer. The processor device may be configured to generate the product-offering matrix based on one or more products selected by the customer. The first display may communicate the matrix to the customer.

For example, the customer may select one of the pre-selected products. The processor may determine that the entity currently offers an additional product that provides an outcome or implements an objective desired by the customer. The processor may determine that if the customer utilizes an additional product offered by the entity, the customer may qualify for a discount or special pricing scheme with respect to the selected product. The processor may determine that based on financial information associated with the customer, the customer may obtain the selected product at a discounted cost. The processor may determine that based on financial information associated with the customer, the customer may qualify for a product offered by the entity.

The kiosk may include a second display. The second display may be configured to communicate to an employee of the entity: (1) an image of the customer, (2) a name of the customer, (3) the selection of the customer, (4) the product-offering matrix, and/or (5) a greeting.

The employee may view the second display prior to servicing the customer. The employee may be provided a period of time to prepare to service the customer. Such preparation may result in the employee providing a higher level of service to the customer.

For example, if the customer input the selection at a location remote from the retail location, the employee may be provided an opportunity to review the selection before the customer arrives at the retail location.

When the customer arrives at the retail location, at the kiosk the customer may provide one or more of the first, second and third inputs. The kiosk, via the second display, may inform the employee that the customer has arrived. The kiosk, via the first display, may communicate to the customer an estimated wait time until the employee is available to service the customer.

While the customer is waiting to be serviced by an employee, the first display may communicate additional information regarding the customer's selection. The first display may communicate information regarding additional financial products offered by the entity. The customer may browse products offered by the entity. The customer may be presented with specific financial products associated with the selection.

Information communicated by the second display may provide the employee with an understanding of why the customer wishes to travel to the retail location and what the customer hopes to accomplish. The employee may prepare a list of alternative products. The alternative products may fulfill the objective of the customer. The alternative products may be identified based on the known to the entity and associated with the customer. The matrix may include the alternative products.

The product-offering matrix may notify the employee of options that may be available to the customer. The employee may research the products included in the matrix. The employee may prepare to discuss alternative options with the customer. An ability to discuss alternative options with the customer may correspond to providing a higher quality of service to the customer.

An employee that is prepared for a discussion with a customer may reduce an amount of time that the employee spends with the customer. A prepared employee may result in increased efficiency of a workforce of the entity.

Embodiments may be configured to allow customers to select a financial product and simulate a performance of the financial product. The customer may simulate different products and observe which products may accomplish an objective or financial goal.

For example, while the customer is waiting to be serviced by an employee, the first display may communicate the product-offering matrix to the customer. The customer may select a product in the matrix and simulate performance of the product. The simulation may be based on financial information associated with the customer. The simulation may be based on financial information known to the entity. In some embodiments the customer may compare simulated performance of two or more products in the matrix.

The kiosk may include a camera oriented to capture an image of the customer. The image may be received by the receiver.

The kiosk may include a transmitter device. The transmitter may be configured to transmit the image captured by the camera to the second display. The second display may communicate an image of the customer to the employee. When the employee is ready to service the customer, the employee may recognize the customer and greet the customer by name. The employee may utilize a greeting communicated by the second display. An ability to recognize the customer and initiate a greeting may result in providing a high level of service to the customer.

The transmitter device may be configured to communicate to the customer a name of an employee assigned to service the customer. The transmitter device may be configured to communicate to the customer biographical information associated with the assigned employee. The biographical information may include educational background, certifications and experience of the employee. The biographical information may be communicated to the customer via the first display. The transmitter device may be configured to communicate to the customer a projected wait-time until the assigned employee is ready to service the customer. The wait-time may be communicated to the customer via the first display.

The transmitter device may be configured to transmit a confirmation code to the customer. For example, the receiver may be configured to receive a fourth input. The fourth input may be generated within an online portal of the financial institution. The fourth input may include the selection of at least one of the pre-selected financial products.

The customer may select a financial product of interest using an online portal of an entity. The customer may indicate that he would like to discuss the selection with an entity employee at a retail location. The receiver may receive the selected product and request submitted by the customer via the online portal. In response to the customer's submission, the transmitter may communicate a Quick Response Code (“QR Code”) to a mobile device of the customer.

The QR Code may include encoded identification information associated with the customer and the product selection of the customer. The kiosk may include a QR code or bar code reader. Upon entering the retail location the customer may display the transmitted QR Code on a mobile device and scan the displayed QR Code at the kiosk. The information encoded in the QR Code may be received by the kiosk. Based on the received QR Code, the employee assigned to service the customer may be notified that the customer has arrived at the retail location.

The processor device may be configured to determine a line-of-business associated with the customer's selection of at least one of the pre-selected financial products. An employee may be assigned to service the customer based on an expertise of the employee and the line-of-business. An employee may be selected to service the customer based on the experience of the employee in a particular line-of-business.

For example, the selection of the customer may relate to a home loan. A line-of-business of the entity may include home loans. An employee of the entity may have experience guiding individuals through a process of obtaining a home loan. An employee of the entity may have experience issuing and servicing home loans.

An employee may be associated with a location of the entity. The employee may be assigned to service a customer based on the associated location. For example, the customer may input an address and request an employee within a distance of the address. The processor may search for an employee within the distance and with experience servicing the product selected by the customer.

In some embodiments, the customer may be associated with an employee. The customer may be associated with an employee based on the selection. The customer may be associated with an employee based on products included in the product-offering matrix. The customer may be associated with the employee based on one of the first, second or third inputs.

Employees at a retail location may not include an employee that possesses experience/expertise with a product that the customer would like to discuss. The customer may be offered an option to conduct a video and/or teleconference with an employee at a remote location. The employee at the remote location may possess the desired experience/expertise.

The customer may be offered to schedule an appointment with an experienced employee at a designated location and designated time. The entity may direct an employee possessing the experience/expertise with the product selected by the customer to travel to the designated location. The appointment may be scheduled at a time and place convenient for the customer. The remote location may include a coffee house or a branch location of the entity.

The processor may derive a list of employees qualified to service the customer. The first display may be configured to communicate the list of employees to the customer. The list of employees may be based on the line-of-business associated with the customer's selection. For example, a retail location may be associated with multiple entity employees possessing experience with a particular product. The customer may select an employee from the list of employees.

The processor device may be configured to select an employee from the list of employees based on an association between the customer and the employee. For example, the customer may have previously discussed a product with a particular entity employee. The customer may desire to further develop a relationship with the particular entity employee. Based on past interactions with the customer, the particular entity employee may possess a deeper understanding of the customer's financial status or financial concerns.

The processor device may be configured to filter the list of employees based on a past association between the customer and the employee. For example, based on a line-of-business associated with the selection of the customer, the customer may be associated with an employee that has experience with the selected product and has previously serviced the customer.

The product-offering matrix may include one or more financial products that share an attribute in common with the selection of the at least one pre-selected financial product. For example, the selection may include a financial product associated with a line-of-business. The matrix may include additional products that share the line-of-business.

The attribute may be based on the financial information. For example, the customer may purchase a dollar-amount of gasoline each month. The matrix may include products that offer discounts on gasoline purchases. The matrix may include products that include special offers to customers that purchase goods valued at or above a threshold value.

Apparatus may include an article of manufacture that includes a computer usable medium. The computer usable medium may include computer readable program code for providing a concierge service to a customer.

The computer readable program code may include program code for causing the computer to receive an identifying characteristic of the customer. The identifying characteristic may include the first, second or third input.

The computer readable program code may include code for causing the computer to generate a fraud indicator based on the identifying characteristic.

For example, the customer may use a purchasing instrument to provide identification to the kiosk. If the purchasing instrument used to identify the customer has been reported lost or stolen, an employee at the retail location may be alerted. If the purchasing instrument used to identify the customer has been reported lost or stolen, the kiosk camera may obtain an image of an individual using the reported stolen purchasing instrument.

The computer readable program code may include code for causing the computer to generate a plurality of pre-selected financial products. The plurality of pre-selected products may include products determined to be most appropriate for a customer. A product may be deemed appropriate based on financial information associated with the customer.

The computer readable program code may include code for causing the computer to receive a financial product selected by the customer. The selected product may include one of pre-selected products. The customer may browse products offered by an entity and select a desired product.

The customer may access financial products by selecting a presented category of financial products. Based on the selected category, class or genre, the customer may be presented with specific products associated with the category. The customer may select a desired product within the category.

The computer readable program code may include code for causing the computer to generate a product-offering matrix. The matrix may be generated based on the selected financial product and a financial status of the customer.

The computer readable program code may include code for causing the computer to generate an image of the customer. The computer readable program code may include code for causing the computer to generate a greeting, the greeting generated based on the image, the identifying characteristic and the product-offering matrix.

For example, the image may indicate whether the customer is male or female. After viewing the image the employee may be identify the customer among other customers waiting to be serviced. The identifying characteristic may include the customer's name and age. The employee may incorporate the information derived from the image, the identifying characteristic and financial information known about the customer to formulate a greeting.

The employee may personalize the greeting by mentioning that the employee is knowledgeable about the product that interests the customer. A personalized greeting that so informs the customer may provide a level of comfort to the customer that the entity has taken time to consider the customer's needs.

The computer readable program code may include code for determining a financial status of the customer. The financial status may be based on stored records associated with the customer. For example, the identification information input by the customer may link the customer to records stored by the entity. Exemplary records may include account balances, loan amounts, address, a credit limit, an investment strategy or any suitable record. The financial status may be determined based on the records.

The financial status may indicate, for example, whether the customer favors a conservative or a more risky investment. The financial status may indicate whether the customer may have excess funds available for a long term investment. If the customer does have excess funds available, the product-offering matrix may include long term investment products.

In some embodiments, the pre-selected financial products may be determined based on the financial status.

Methods may include receiving the first input from the customer. The first input may include identification information encoded on a purchasing instrument of the customer. Methods may include receiving the second input. The second input may include identification information transmitted from a mobile device of the customer. Methods may include receiving the third input. The third input may include a biometric characteristic of the customer. The biometric characteristic may identify the customer.

Methods may include determining the plurality of pre-selected financial products. The determining may be based on one or more of the first input, the second input and the third input. The determining may be based on the financial status of the customer.

Methods may include receiving, from the customer, a selection of at least one of the plurality of pre-selected financial products.

Methods may include determining the product-offering matrix. The matrix may be determined based on the pre-selected financial products, the selection of the customer and/or the financial status of the customer. Methods may include transmitting to an entity employee an image of the customer, a name of the customer, the selection of the customer, the product-offering matrix and a greeting.

Methods may include conducting a video conference and/or teleconference with the customer and an entity employee. For example, an entity employee possessing expertise with a product of interest to the customer may be located a distance from the customer's home. The customer and the entity employee may conduct a video conference to discuss the product of interest. The customer may conduct the video conference from home.

Methods may include ranking each of the pre-selected financial products. Methods may include ranking each of the products included in the product-offering matrix.

Products may be ranked based on a perceived relevance to the customer. The relevance may be based on the financial status. The relevance may be based on a past transaction of the customer. Methods may include displaying the products based on the ranking.

For example, based on a high frequency use of a purchasing instrument, the product-offering matrix may include a new pricing scheme associated with the purchasing instrument. The new pricing scheme may be ranked higher than an alternative purchasing instrument included in the product-offering matrix.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

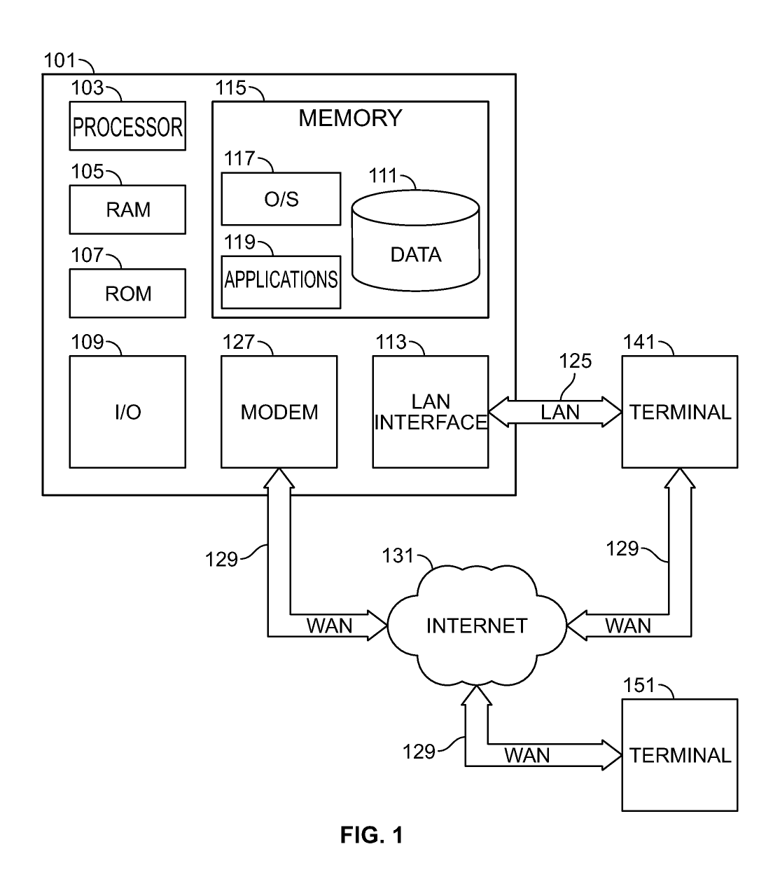

FIG. 1 is a block diagram that illustrates a generic computing device 101 (alternatively referred to herein as a “server”) that may be used in accordance with the principles of the invention. Server 101 may be included in any suitable apparatus that is shown or described herein.

Server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternatively, some or all of server 101 computer executable instructions may be embodied in hardware or firmware (not shown). Database 111 may provide storage for customer inputs, customer records, financial information, products offered by an entity and/or any other suitable information.

Server 101 may operate in a networked environment supporting connections to one or more remote computers, such as terminals 141 and 151. Terminals 141 and 151 may be servers that include many or all of the elements described above relative to server 101. The network connections depicted in FIG. 1 include a local area network (LAN) 125 and a wide area network (WAN) 129, but may also include other networks such as an intranet. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, blackberry, or any other suitable device for storing, transmitting and/or transporting relevant information.

Any information described above in connection with database 111, and any other suitable information, may be stored in memory 115.

One or more of applications 119 may include one or more algorithms that may be used to provide a retail location concierge station.

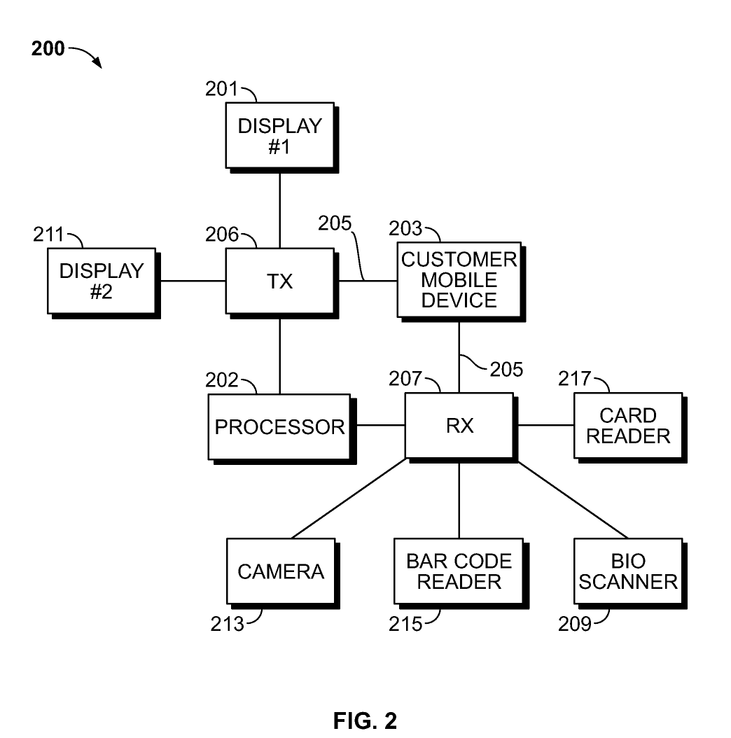

FIG. 2 shows illustrative apparatus 200. Apparatus 200 may have one or features in common with Server 101 (shown in FIG. 1). Apparatus 200 may have one or more features in common with a retail location concierge station. Apparatus 200 includes processor 202. Processor 202 may have one or more of features in common with processor 103 (shown in FIG. 1).

Apparatus 200 includes receiver 207. Receiver 207 may receive identification information, product selections or any suitable input from a customer. Receiver 207 receives input from mobile device 203 over communication link 205. Link 205 may be wired or wireless. Link 205 may be any communication medium suitable for long or short range communication. Link 205 is an exemplary link and components of apparatus 200 may communicate with each other utilizing a link having one or more features in common with link 205.

Apparatus 200 includes transmitter 206. Transmitter 206 may communicate instructions from processor 202 to display 211, display 201 and mobile device 203. Display 201 may be configured to present pre-selected products, a product-offering matrix, or any suitable information to a customer using a concierge station. Display 201 may be a touch screen. Display 201 may have one or more features in common with input/output module 109 (shown in FIG. 1).

Display 211 may be configured to present information to an entity employee. Display 211 may communicate to the entity employee a financial status of the customer. Display 211 may communicate a product-offering matrix to the employee. Display 211 may communicate a greeting to the employee. Display 211 may have one or more features in common with input/output module 109 (shown in FIG. 1).

Apparatus 200 includes card reader 217. Card reader 217 may be configured to read information encoded on a purchasing instrument. The encoded information may include identification information of a customer.

Apparatus 200 may include bar code reader 215. Bar code reader 215 may be configured to read a QR Code. The QR Code may include identification information of a customer. The QR Code may include an identifier that associates a customer submitting the QR Code with a previously submitted product selection. Bar code reader 215 communicates with processor 202 via receiver 207.

Processor 202 may be configured to receive input from bio scanner 209 via receiver 207. Bio scanner 209 may be configured to capture a biometric characteristic of a customer. The biometric characteristic may uniquely identify the customer. Based on the captured biometric credentials, processor 202 may instruct display 201 (via transmitter 206) to present pre-selected products, a product-offering matrix or other suitable information to the customer.

Apparatus 200 may include camera 213. Camera 213 may be oriented to capture an image of the customer. Receiver 207 may receive an image captured by camera 213. The image may be transmitted to second display 211 via transmitter 206.

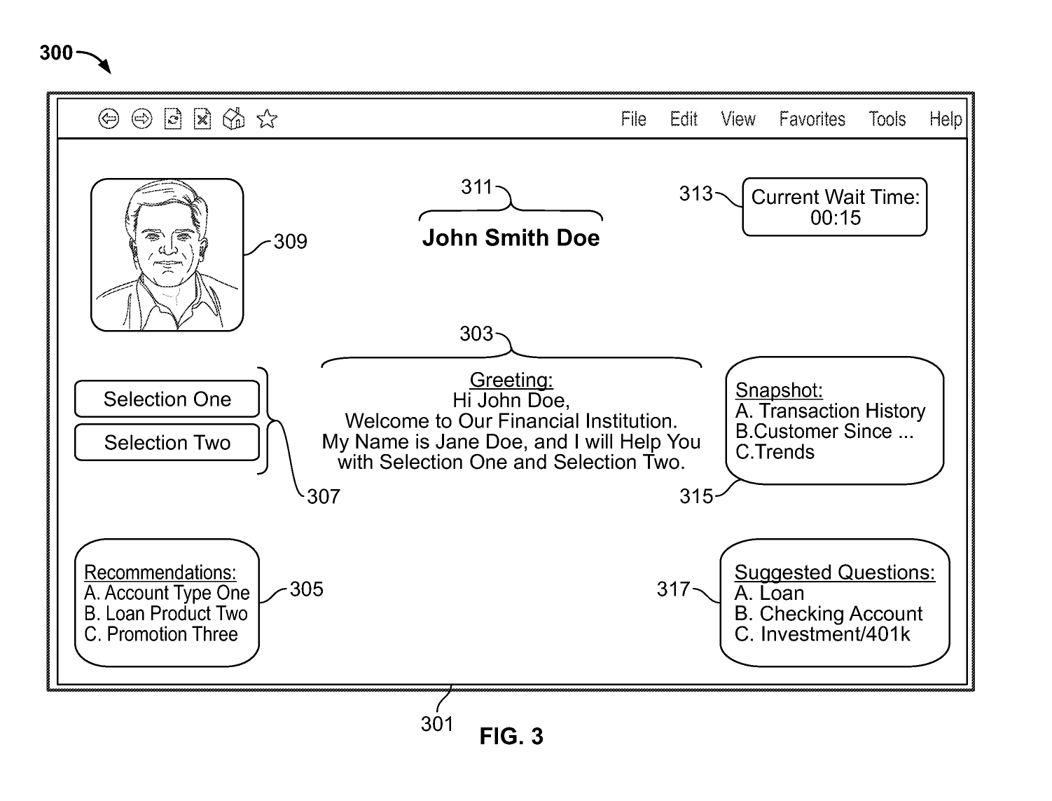

FIG. 3 shows illustrative information 300. Information 300 may be communicated via display 201 or display 211 (shown in FIG. 2).

Information 300 includes customer name 311. Customer name 311 may be obtained based on an input received at transmitter/receiver 207 (shown in FIG. 2). Information 300 includes image 309. Image 309 may be captured using camera 213 (shown in FIG. 2). Image 309 may provide a visual description of a customer to an entity employee.

Information 300 includes selections 307. Selections 307 may be products selected by a customer. Selections 307 indicate that a customer has expressed an interest in selections 307. An employee of the entity may prepare to discuss selections 307 with customer 311.

Information 300 includes product-offering matrix 305. Matrix 305 includes products that may benefit customer 311. Matrix 305 may be generated based on financial information associated with customer 311. The financial information may be stored and associated with customer 311 in database 111 (shown in FIG. 1).

Information 300 includes snapshot 315. Snapshot 315 may provide a synopsis of the financial information stored in database 111 and associated with customer 311. Snapshot 315 may provide an employee with information that may be used to advise customer 311.

Information 300 may include exploratory questions 317. Questions 317 may be generated based on financial information stored in database 111. Questions 317 may be generated based on selections 307. Questions 317 may guide an entity employee servicing customer 311. Questions 317 may guide the employee to inquire whether customer 317 may benefit from additional products offered by an entity.

Information 300 includes greeting 303. Greeting 303 may be a suggested template to be used when an employee is greeting customer 311. Greeting 303 includes the name of customer 311 and acknowledges that the employee is aware of the reason customer 311 has visited the retail location.

Information 300 includes wait-time 313. Wait-time 313 indicates approximately how long customer 311 has been waiting. Wait-time 313 may be calculated from a time customer 311 provides identification information.

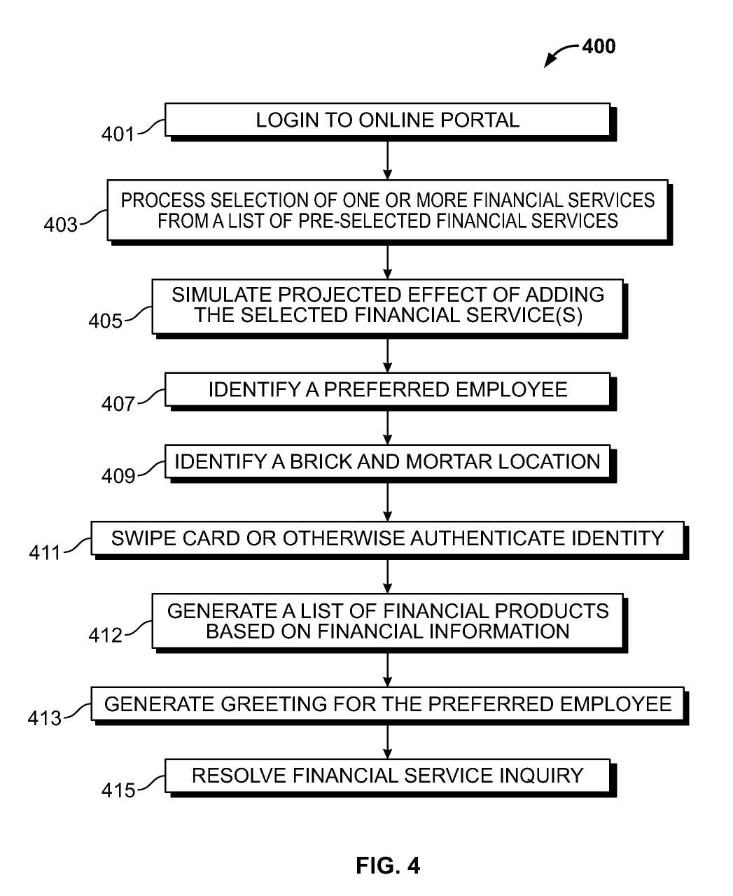

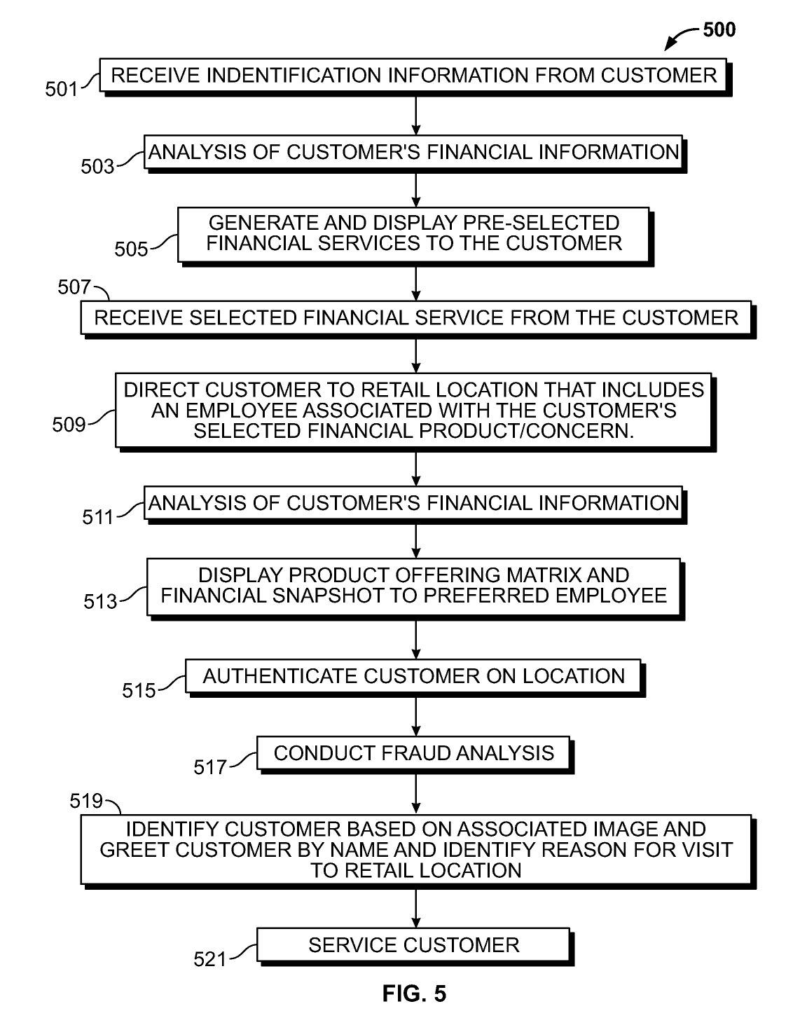

Processes in accordance with the principles of the invention may include one or more features of the processes illustrated in FIGS. 4-5. The steps of the illustrated processes are performed by a “system.” The “system” includes one or more of the features of the apparatus and methods described herein. The “system” may be provided by an entity. The entity may be an individual, an organization or any other suitable entity.

FIG. 4 shows illustrative process 400. Apparatus and methods according to principles of the invention implement the steps of process 400.

At step 401, the system processes a customer login to an online portal. The online portal may be provided by an entity. The online portal may provide access to products offered by the entity. At step 403, the system processes a selection of one or more financial services from a list of pre-selected financial services. The selected products may correspond to products of interest to the customer.

At step 405, the system simulates a projected effect of adding the selected financial service(s) to a pre-existing relationship between the entity and the customer. The simulation may indicate how a product may interact with other entity products used by the customer. The simulation may provide information for the customer to gauge how a product may perform given the information known to the entity about the customer.

At step 407, the system may select a preferred employee. The preferred employee may be selected as a result of a past experience with an entity product. The preferred employee may be selected as a result of past training experience. The preferred employee may be selected as a result of an association with a line-of-business of the entity.

At step 409, the system may identify a retail location. The retail location may be a location of the preferred employee. The retail location may be selected based on a location of a customer.

At step 411, the system may receive and authenticate identification information provided by the customer. The identification information may associate financial information stored in database 111 (shown in FIG. 1) with the customer.

At step 412, the system may generate financial products based on the financial information. The financial products may include products offered by the entity that the customer may qualify to use based on the financial information. The system may present the financial products as a product-offering matrix.

At step 413, the system generates a greeting for the preferred employee. The preferred employee may utilize the greeting when interacting with the customer.

At step 415, based on the information provided by the system, the preferred employee may resolve a financial service inquiry of the customer.

FIG. 5 shows illustrative process 500. Process 500 shows illustrative steps that may be performed by the system. At step 501, the system receives identification information from a customer. At step 503, the system performs an analysis of the customer's financial information known to the entity. At step 505, the system generates and displays pre-selected financial services to the customer. At step 507, the system receives a selected financial service from the customer. The customer may select the financial service using a mobile device or a computer at the customer's home.

At step 509, the system directs the customer to a retail location that is associated with an employee qualified to service the customer's selected financial product. At step 511, the system performs an analysis of customer's financial information based on the selected financial service. The analysis may determine if there may be additional entity products of potential interest to the customer.

At step 513, the system displays a product-offering matrix and financial snapshot to the qualified employee. The qualified employee may be assigned to service the customer at the retail location. At step 515, the system authenticates the customer at the retail location.

At step 517, the system conducts a fraud analysis. The fraud analysis may compare identification information input to the system by the customer using a purchasing instrument to irregular activity patterns associated with the purchasing instrument. The irregular activity patterns may be associated with a lost or stolen purchasing instrument.

At step 519, the system presents an image of the customer to the employee assigned to service the customer. The associated image may be obtained via camera 213 (shown in FIG. 2). Step 519 includes a notification to the entity employee that the customer has arrived at the retail location. Step 519 includes generating a greeting that includes the customer's name and a reason why the customer is visiting the retail location.

At step 521, based on analysis and information provided by the system, the employee provides service to the customer.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Thus, methods and apparatus for a retail location concierge station have been provided. Persons skilled in the art will appreciate that the present invention can be practiced by other than the described embodiments, which are presented for purposes of illustration rather than of limitation, and that the present invention is limited only by the claims that follow.

What is claimed is:

1. A customer-facing concierge kiosk for servicing a customer at a financial institution having a retail location, the kiosk comprising:
a receiver device configured to receive:
a first input from the customer, the first input comprising information encoded on a purchasing instrument of the customer;
a second input, the second input comprising information transmitted from a mobile device of the customer;
a third input, the third input comprising a biometric characteristic of the customer;
a first display configured to communicate pre-selected financial products to the customer;
an input device configured to receive a selection of the customer, the selection comprising at least one of the pre-selected financial products;
a processor device configured to:
determine the pre-selected financial products based on:
one or more of the first input, the second input and the third input;
financial information associated with the customer; and
generate a product-offering matrix, the matrix based on the financial information associated with the customer and the selection of the customer; and
a second display configured to communicate:
an image of the customer;
a name of the customer;
the selection of the customer;
the product-offering matrix; and
a greeting.

2. The kiosk of claim 1 further comprising a transmitter device, the transmitter device configured to communicate to the customer:
a name of an employee assigned to service the customer;
biographical information of the assigned employee; and
a projected wait-time until the assigned employee is ready to service the customer.

3. The kiosk of claim 1, wherein the processor device is configured to determine a line-of-business associated with the selection of the customer.

4. The kiosk of claim 2, wherein the processor device is configured to assign the employee based on an expertise of the employee and a line-of-business associated with the selection of the customer.

5. The kiosk of claim 3 wherein the first display is configured to communicate a list of employees available to service the customer, the list of employees based on the line-of-business.

6. The kiosk of claim 5, wherein the input device is configured to receive an input selecting an employee from the list of employees.

7. The kiosk of claim 5 wherein the processor device is configured to select an employee from the list of employees based on an association between the customer and the employee.

8. The kiosk of claim 5 wherein the processor device is configured to filter the list of employees based on a past association between the customer and the employee.

9. The kiosk of claim 1 wherein the input device is the mobile device of the customer.

10. The kiosk of claim 1 wherein the receiver is configured to receive:
a fourth input, the fourth input generated within an online portal of the financial institution; and
the fourth input comprises the selection of the at least one of the pre-selected financial products.

11. The kiosk of claim 1 further comprising a camera oriented to capture an image of the customer.

12. The kiosk of claim 11 wherein a transmitter is configured to transmit an image captured by the camera to the second display.

13. The kiosk of claim 11 further comprising a video conferencing room.

14. The kiosk of claim 1 wherein the product-offering matrix comprises one or more financial products that share an attribute in common with the selection of the at least one of the pre-selected financial products.

15. The kiosk of claim 14 wherein the attribute is based on the financial information associated with the customer.

16. The kiosk of claim 1 wherein the first display is configured to display the pre-selected financial products in an order, the order determined by the processor device and based on the financial information associated with the customer.

17. An article of manufacture comprising:
a computer usable medium having computer readable program code embodied therein for providing a concierge service to a customer, the computer readable program code in said article of manufacture comprising:
computer readable program code for causing the computer to receive an identifying characteristic of the customer;
computer readable program code for causing the computer to generate a fraud indicator based on the identifying characteristic;
computer readable program code for causing the computer to generate a plurality of pre-selected financial products;
computer readable program code for causing the computer to receive a selected financial product, wherein the financial product is selected by the customer;
computer readable program code for causing the computer to generate a product-offering matrix, the matrix generated based on the selected financial product and a financial status of the customer;
computer readable program code for causing the computer to capture an image of the customer;
computer readable program code for causing the computer to generate a greeting comprising the image, the greeting generated based on the identifying characteristic and the product-offering matrix.

18. One or more non-transitory computer-readable media storing computer-executable instructions, that when executed by a processor on a computer system provides a concierge service to a customer, the instructions comprising instructions for:
receiving a first input from the customer, the first input comprising information encoded on a purchasing instrument of the customer;
receiving a second input, the second input comprising information transmitted from a mobile device of the customer;
receiving a third input, the third input comprising a biometric characteristic of the customer;
determining a plurality of pre-selected financial products based on:
one or more of the first input, the second input and the third input; and
a financial status of the customer; and
receiving, from the customer, a selection of at least one of the plurality of pre-selected financial products;
determining a product-offering matrix, the matrix based on the selection and the financial status of the customer; and
transmitting to an employee of the financial institution:
an image of the customer;
a name of the customer;
the selection;
the product-offering matrix; and
a greeting.

19. The media of claim 18, the instructions further comprising instructions for conducting a video conference with the customer and the employee.

20. The media of claim 18 the instructions further comprising instructions for:
ranking each of the plurality of pre-selected financial products; and
displaying the plurality of pre-selected financial products based on the ranking.
